(19) United States
(12) Patent Application Publication
(10) Pub. No.: US 2026/0367658 A1
(43) Pub. Date: Nov. 19, 2026

(54) LOW-DROPOUT REGULATOR AND SHORT-CIRCUIT RECOVERY SOFT-START PROTECTION CIRCUIT

(71) Applicant: ANPEC ELECTRONICS CORPORATION, HSINCHU (TW)

(72) Inventors: HSUAN-LI KUNG, HSINCHU CITY (TW); CHIH-NING CHEN, TAIPEI CITY (TW); CHIH-HENG SU, Hsinchu City (TW)

(21) Appl. No.: 19/310,936

(22) Filed: Aug. 27, 2025

(30) Foreign Application Priority Data
May 13, 2025 (TW) 114117793

(51) Int. Cl. G05F 1/571; G05F 1/46; G05F 1/575

(52) U.S. Cl. CPC G05F 1/571; G05F 1/468; G05F 1/575

(57) ABSTRACT

A short-circuit recovery soft-start protection circuit is applied to a low-dropout regulator, and includes a clamp circuit and a soft-starting reference circuit. The clamp circuit includes a voltage difference providing circuit, an operational amplifier and a switch component. The voltage difference providing circuit provides a voltage difference between a first input terminal of the low-dropout regulator and a first input terminal of the operational amplifier. A second input terminal of the operational amplifier is connected to an output terminal of the low-dropout regulator. A first terminal of the switch component is connected to a buffer reference node. A control terminal of the switch component is connected to an output terminal of the operational amplifier. The soft-starting reference circuit charges a voltage of the buffer reference node to a reference voltage.

### CROSS-REFERENCE TO RELATED PATENT APPLICATION

This application claims the benefit of priority to Taiwan Patent Application No. 114117793, filed on May 13, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a low-dropout regulator, and more particularly to a low-dropout regulator and a short-circuit recovery soft-start protection circuit.

### BACKGROUND OF THE DISCLOSURE

A low-dropout regulator (LDO) is a type of linear DC regulator that supplies a stable DC voltage. Compared to general linear regulators, the LDO is able to operate with a smaller input-to-output voltage difference.

During operation of the LDO, load transition may occur, potentially causing a sudden short circuit at an output terminal of the LDO. This can result in an instantaneous output voltage overshoot, which may damage both the LDO and the load.

### SUMMARY OF THE DISCLOSURE

In response to the above-referenced technical inadequacies, the present disclosure provides a low-dropout regulator. The low-dropout regulator includes an error amplifier and a short-circuit recovery soft-start protection circuit. A first input terminal of the error amplifier is connected to a buffer reference node. An output terminal of the error amplifier is connected to a feedback node and a second input terminal of the error amplifier. The short-circuit recovery soft-start protection circuit includes a clamp circuit and a soft-switching reference circuit. The clamp circuit includes clamp circuit, a voltage difference providing circuit and a switch component. The operational amplifier has a first input terminal and a second input terminal. The second input terminal is connected to the feedback node. The voltage difference providing circuit is connected between the buffer reference node and the first input terminal of the operational amplifier. The voltage difference providing circuit is configured to provide a voltage difference between the buffer reference node and the first input terminal of the operational amplifier. A first terminal of the switch component is connected to the buffer reference node. A second terminal of the switch component is grounded. A control terminal of the switch component is connected to an output terminal of the operational amplifier. The soft-switching reference circuit is connected to the buffer reference node, and configured to charge a voltage of the buffer reference node to a reference voltage.

In order to solve the above-mentioned problems, one of the technical aspects adopted by the present disclosure is to provide a short-circuit recovery soft-start protection circuit. The short-circuit recovery soft-start protection circuit is applicable to a low-dropout regulator. A first input terminal of the low-dropout regulator is connected to a buffer reference node. An output terminal of the low-dropout regulator is connected to a feedback node and a second input terminal of the low-dropout regulator. The short-circuit recovery soft-start protection circuit includes the clamp circuit and the soft-switching reference circuit that are described above.

As described above, the present disclosure provides the low-dropout regulator and the short-circuit recovery soft-start protection circuit applied thereto. When a short-circuit event occurs in an output terminal of the low-dropout regulator, the short-circuit recovery soft-start protection circuit of the present disclosure is able to pull down a soft startup reference voltage of an input terminal of the low-dropout regulator for pulling down an output voltage signal of the output terminal of the low-dropout regulator. Therefore, the low-dropout regulator is prevented from being damaged by overshoot of the output voltage thereof.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a low-dropout regulator and a short-circuit recovery soft-start protection circuit according to a first embodiment of the present disclosure;

FIG. 2 is a low-dropout regulator and a short-circuit recovery soft-start protection circuit according to a second embodiment of the present disclosure;

FIG. 3 is a low-dropout regulator and a short-circuit recovery soft-start protection circuit according to a third embodiment of the present disclosure;

FIG. 4 is a low-dropout regulator and a short-circuit recovery soft-start protection circuit according to a fourth embodiment of the present disclosure;

FIG. 5 is a low-dropout regulator and a short-circuit recovery soft-start protection circuit according to a fifth embodiment of the present disclosure; and

FIG. 6 is a low-dropout regulator and a short-circuit recovery soft-start protection circuit according to a sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

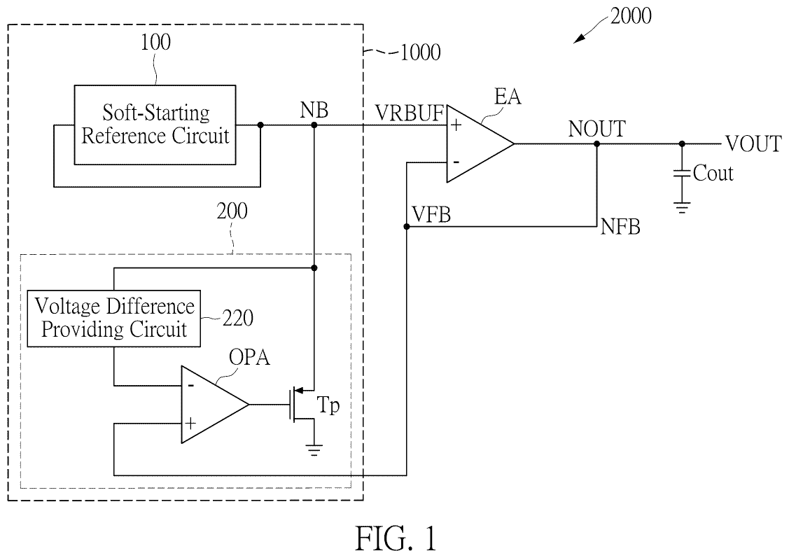

Reference is made to FIG. 1, which is a low-dropout regulator and a short-circuit recovery soft-start protection circuit according to a first embodiment of the present disclosure.

As shown in FIG. 1, in the first embodiment, a low-dropout regulator 2000 of the present disclosure includes a short-circuit recovery soft-start protection circuit 1000 and an error amplifier EA. In other words, the short-circuit recovery soft-start protection circuit 1000 of the present disclosure is applied to the low-dropout regulator 2000 including the error amplifier EA.

It is worth noting that, the short-circuit recovery soft-start protection circuit 1000 includes a soft-switching reference circuit 100 and a clamp circuit 200. In particular, the clamp circuit 200 includes a voltage difference providing circuit 220, an operational amplifier OPA and a switch component Tp.

A first input terminal such as a non-inverting input terminal of the error amplifier EA is connected to a buffer reference node NB. A second input terminal such as an inverting input terminal of the error amplifier EA is connected to an output terminal of the error amplifier EA. An output terminal of the error amplifier EA is connected to an output node NOUT, and the output node NOUT is further connected to a feedback node NFB.

The voltage difference providing circuit 220 is connected between the feedback node NFB and a first input terminal such as an inverting input terminal of the operational amplifier OPA. For example, the voltage difference providing circuit 220 may include a voltage source. As shown in FIG. 1, the first input terminal of the operational amplifier OPA is connected to a first terminal (such as a negative terminal) of the voltage difference providing circuit 220. The buffer reference node NB (or the first input terminal such as the non-inverting input terminal of the error amplifier EA) is connected to a second terminal (such as a positive terminal) of the voltage difference providing circuit 220. A second input terminal such as a non-inverting input terminal of the operational amplifier OPA is connected to the feedback node NFB.

A first terminal of the switch component Tp is connected to the feedback node NFB. A second terminal of the switch component Tp is grounded. A control terminal of the switch component Tp is connected to an output terminal of the operational amplifier OPA.

If necessary, the low-dropout regulator 2000 of the present disclosure may further include an output circuit. For example, the output circuit includes an output capacitor Cout. A first terminal of the output capacitor Cout is connected to the output node NOUT. A second terminal of the output capacitor Cout is grounded. The first terminal of the output capacitor Cout or the output node NOUT may be connected to a load.

An output voltage signal VOUT of the output node NOUT or the first terminal of the output capacitor Cout is used as a feedback signal VFB, and is fed back to the second input terminal such as the non-inverting input terminal of the operational amplifier OPA through the feedback node NFB. As a result, a voltage of the second input terminal of the operational amplifier OPA is equal to a feedback voltage of the feedback signal VFB. A voltage of the first input terminal of the operational amplifier OPA is equal to a voltage of the second input terminal of the operational amplifier OPA.

The voltage difference providing circuit 220 is configured to provide a voltage difference between the first input terminal of the operational amplifier OPA and the buffer reference node NB.

It is worth noting that, during operation, transition in the load may cause the output terminal of the error amplifier EA to enter a sudden short-circuit state. After a brief interval, the error amplifier EA recovers to its normal operating state. Consequently, an overshoot event occurs in an output voltage signal VOUT. In order to prevent the error amplifier EA and the load from being damaged due to the overshoot of the output voltage signal VOUT, the low-dropout regulator 2000 of the present disclosure not only includes the error amplifier EA, but further includes the short-circuit recovery soft-start protection circuit 1000.

When a short-circuit event occurs in the output voltage signal VOUT of the output node NOUT connected to the output terminal of the error amplifier EA of the low-dropout regulator, in the short-circuit recovery soft-start protection circuit 1000, the output terminal of the operational amplifier OPA outputs an operation amplified signal having a trigger level (such as a low level) to the control terminal of the switch component Tp for turning on the switch component Tp. At this time, the buffer reference node NB connected to the first input terminal such as the non-inverting input terminal of the error amplifier EA is connected to a ground through the switch component Tp being turned on. As a result, a soft startup reference voltage VRBUF at the first input terminal of the error amplifier EA is pulled down to be equal to a sum of the feedback voltage of the feedback signal VFB and the voltage difference provided by the voltage difference providing circuit 220.

Therefore, the short-circuit recovery soft-start protection circuit 1000 of the present disclosure is capable of preventing both the error amplifier EA of the low-dropout regulator 2000 of the present disclosure and the load connected thereto from being damaged by the overshoot of the output voltage signal VOUT of the output node NOUT connected to the output terminal of the error amplifier EA.

An initial voltage of the buffer reference node NB is equal to a sum of the first input terminal such as the inverting input terminal of the operational amplifier OPA and the voltage difference provided by the voltage difference providing circuit 220. Therefore, after the output voltage signal VOUT is released, the soft-switching reference circuit 100 directly charges the soft startup reference voltage VRBUF of the feedback node NFB from an initial voltage being higher than a zero value, rather than charging from the zero value, thereby reducing time needed to reach the reference voltage VREF. Therefore, in the low-dropout regulator 2000 of the present disclosure, the soft-switching reference circuit 100 is able to slowly charge the soft startup reference voltage VRBU at the buffer reference node NB, which is connected to the first input terminal of the error amplifier EA. This enables a soft startup of the error amplifier EA, which then supplies the output voltage signal VOUT with the required output voltage for the load.

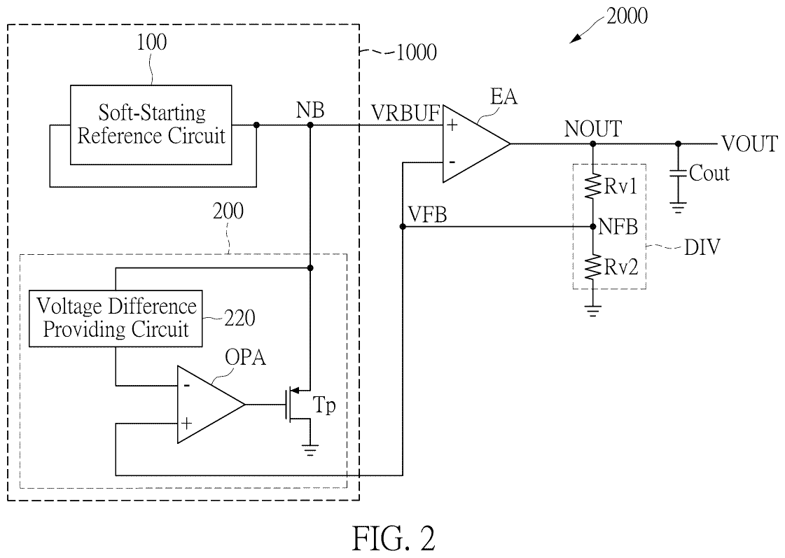

Reference is made to FIG. 2, which is a low-dropout regulator and a short-circuit recovery soft-start protection circuit according to a second embodiment of the present disclosure.

The descriptions of the second embodiment of the present disclosure that are the same as the descriptions of the first embodiment of the present disclosure are not repeated herein.

A difference between the second and first embodiments of the present disclosure is that, as shown in FIG. 2, in the second embodiment, the low-dropout regulator 2000 of the present disclosure further includes a voltage dividing circuit DIV.

The voltage dividing circuit DIV is connected to the output node NOUT and the feedback node NFB.

The voltage dividing circuit DIV may divide the output voltage of the output voltage signal VOUT to generate a voltage divided signal having a divided voltage of the output voltage, as the feedback signal VFB. The voltage dividing circuit DIV may output the feedback signal VFB to the feedback node NFB.

For example, the voltage dividing circuit DIV includes a first voltage dividing resistor Rv1 and a second voltage dividing resistor Rv2. A first terminal of the first voltage dividing resistor Rv1 is connected to the output node NOUT. A first terminal of the second voltage dividing resistor Rv2 is connected to a second terminal of the first voltage dividing resistor Rv1. A second terminal of the second voltage dividing resistor Rv2 is grounded. A node between the first terminal of the second voltage dividing resistor Rv2 and the second terminal of the first voltage dividing resistor Rv1 is connected to or used as the feedback node NFB.

As shown in FIG. 1, the feedback voltage of the feedback signal VFB is equal to the output voltage of the output voltage signal VOUT. In contrast, as shown in FIGS. 2 to 6, the feedback voltage of the feedback signal VFB is equal to the divided voltage of the output voltage of the output voltage signal VOUT, but in practice, may be equal to the output voltage as shown in FIG. 1.

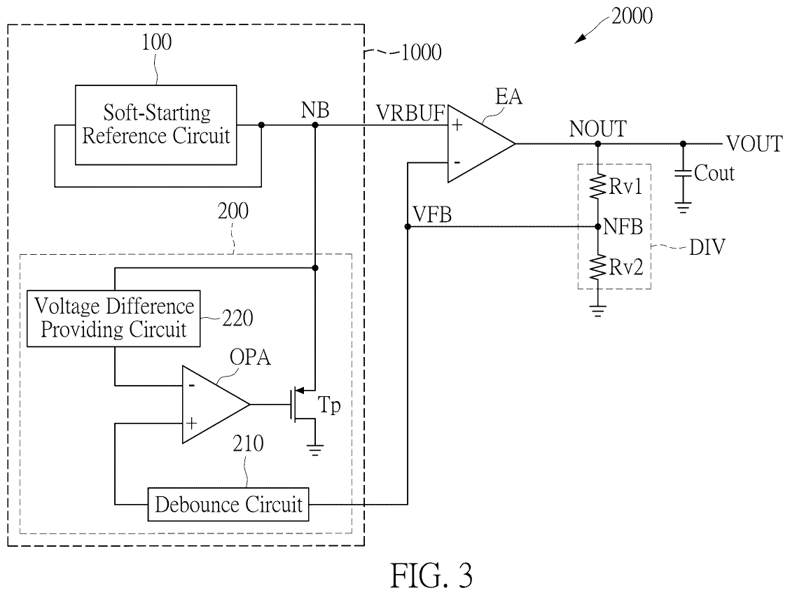

Reference is made to FIG. 3, which is a low-dropout regulator and a short-circuit recovery soft-start protection circuit according to a third embodiment of the present disclosure.

The descriptions of the third embodiment of the present disclosure that are the same as the descriptions of the first and second embodiments of the present disclosure are not repeated herein.

It should be understood that, an instantaneous transition in the load may cause a very low-frequency waveform to be generated in the feedback signal VFB, falsely triggering the clamping circuit 200 to drop a voltage of the first input terminal such as the non-inverting input terminal of the error amplifier EA. As a result, the output node NOUT connected to the output terminal of the error amplifier EA of the low-dropout regulator 2000 is unable to normally supply the output voltage signal VOUT required for the load.

In order to prevent the clamping circuit 200 from being falsely triggered, as shown in FIG. 3, in the third embodiment, the clamp circuit 200 of the short-circuit recovery soft-start protection circuit 1000 of the present disclosure not only includes the voltage difference providing circuit 220, the operational amplifier OPA and the switch component Tp, but further includes a debounce circuit 210.

The debounce circuit 210 is connected between the feedback node NFB and the second input terminal such as the non-inverting input terminal of the operational amplifier OPA. An input terminal of the debounce circuit 210 is connected to the feedback node NFB. An output terminal of the debounce circuit 210 is connected to the second input terminal of the operational amplifier OPA.

Before the feedback signal VFB of the feedback node NFB is outputted to the second input terminal such as the non-inverting input terminal of the operational amplifier OPA, the debounce circuit 210 cuts off entire waveforms each having a frequency being larger than a frequency threshold from the feedback signal VFB, or cuts off one or more waveform segments that do not exceed a falling edge of a debounce reference waveform from the waveforms each having the frequency being larger than the frequency threshold in the feedback signal VFB. The debounce circuit 210 transmits the one or more remaining waveform segments of the waveforms of the feedback signal VFB that are not cut off to the second input terminal of the operational amplifier OPA. As a result, the debounce circuit 210 only transmits the waveforms each having the frequency being larger than the frequency threshold in the feedback signal VFB of the feedback node NFB to the second input terminal of the operational amplifier OPA.

For example, the debounce circuit 210 determines whether or not the frequency of each of the waveforms of the feedback signal VFB of the feedback node NFB is larger than a frequency of the debounce reference waveform of a debounce reference signal. This frequency of the debounce reference waveform may be used as the frequency threshold described above.

When the debounce circuit 210 determines that the frequency of any one of the waveforms of the feedback signal VFB of the feedback node NFB is not larger than the frequency of the debounce reference waveform, the debounce circuit 210 does not transmit the one of the waveforms of the feedback signal VFB to the second input terminal such as the non-inverting input terminal of the operational amplifier OPA.

Conversely, when the debounce circuit 210 determines that the frequency of any one of the waveforms of the feedback signal VFB of the feedback node NFB is larger than the frequency of the debounce reference waveform, the debounce circuit 210 aligns a rising edge of the one of the waveforms of the feedback signal VFB with a rising edge of the debounce reference waveform. Then, the debounce circuit 210 determines whether or not each one of the plurality of waveform segments included in the one of the waveforms of the feedback signal VFB exceeds the falling edge of the debounce reference waveform.

Further, when any one of the waveforms of the feedback signal VFB exceeds the falling edge of the debounce reference waveform, the debounce circuit 210 only captures an incomplete waveform including the waveform segments which exceed the falling edge of the debounce reference waveform from the feedback signal VFB, and only transmits the incomplete waveform (that is a portion of the feedback signal VFB) to the second input terminal such of the operational amplifier OPA.

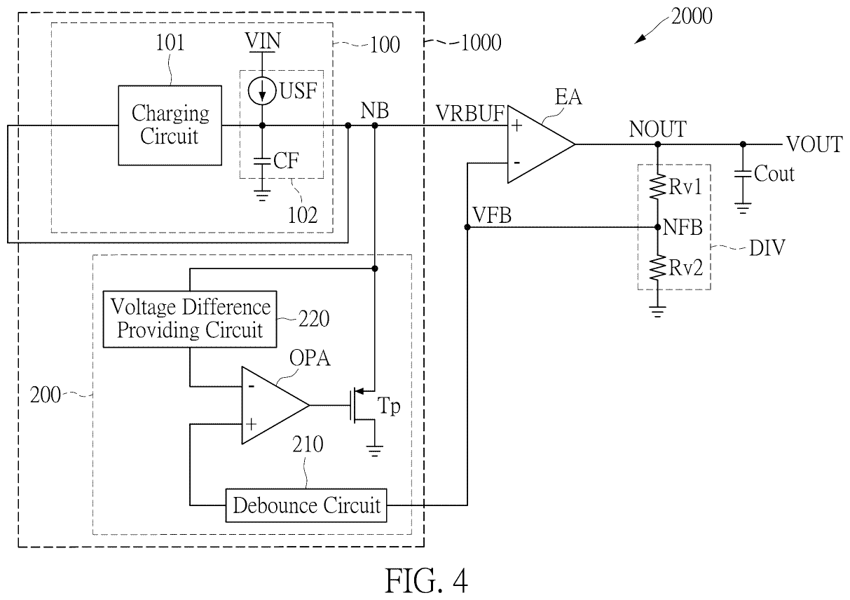

Reference is made to FIG. 4, which is a low-dropout regulator and a short-circuit recovery soft-start protection circuit according to a fourth embodiment of the present disclosure.

The descriptions of the fourth embodiment of the present disclosure that are the same as the descriptions of the first to third embodiments of the present disclosure are not repeated herein. A difference between the fourth and third embodiments of the present disclosure is that, as shown in FIG. 4, in the fourth embodiment, the soft-switching reference circuit 100 includes a charging circuit 101 and a buffer reference voltage generating circuit 102.

The buffer reference voltage generating circuit 102 is connected to the charging circuit 101 and the buffer reference node NB. The charging circuit 101 is connected to the buffer reference node NB.

The charging circuit 101 is configured to charge the buffer reference voltage generating circuit 102 such that the buffer reference voltage generating circuit 102 supplies a charge voltage to the feedback node NFB for charging the buffer reference node NB to the buffer reference node NB.

For example, the buffer reference voltage generating circuit 102 includes a reference capacitor CF (and a reference current source USF). A first terminal of the reference capacitor CF is connected to the charging circuit 101, the first input terminal such as the non-inverting input terminal of the error amplifier EA (and the reference current source USF).

The reference current source USF may supply a reference input current to the first terminal of the reference capacitor CF. The charging circuit 101 sets or modulates a current value of a charging current according to the soft startup reference voltage VRBUF of the feedback node NFB, and supplies the charging current to the reference capacitor CF for charging the soft startup reference voltage VRBUF of the buffer reference node NB to the reference voltage VREF.

The soft startup reference voltage VRBUF of the first terminal of the reference capacitor CF is inputted to the first input terminal such as the non-inverting input terminal of the error amplifier EA through the buffer reference node NB.

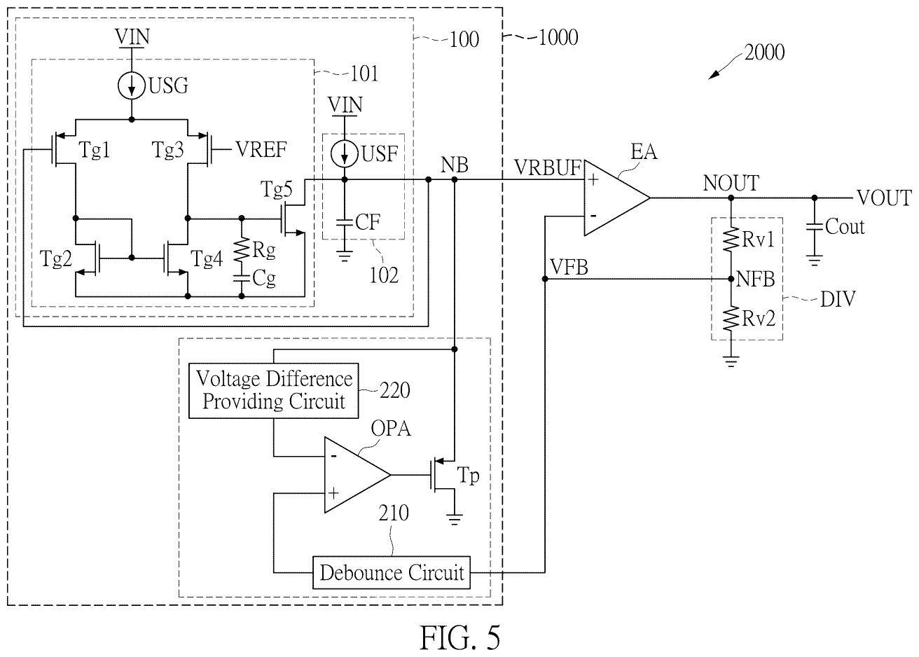

Reference is made to FIG. 5, which is a low-dropout regulator and a short-circuit recovery soft-start protection circuit according to a fifth embodiment of the present disclosure.

The descriptions of the fifth embodiment of the present disclosure that are the same as the descriptions of the first to fourth embodiments of the present disclosure are not repeated herein. A difference between the fifth and fourth embodiments of the present disclosure is that, as shown in FIG. 5, in the fifth embodiment, the charging circuit 101 includes a first transistor Tg1, a second transistor Tg2, a third transistor Tg3, a fourth transistor Tg4, a fifth transistor Tg5, an input current source USG, an input resistor Rg and an input capacitor Cg, one or more of which may be omitted in practice.

An input terminal of the reference current source USF is coupled to an input voltage VIN. A first terminal of the first transistor Tg1 is connected to an output terminal of the input current source USG. A control terminal of the first transistor Tg1 is connected to the feedback node NFB.

A first terminal of the second transistor Tg2 is connected to a second terminal of the first transistor Tg1.

A first terminal of the third transistor Tg3 is connected to the output terminal of the input current source USG. A control terminal of the third transistor Tg3 is coupled to the reference voltage VREF.

A first terminal of the fourth transistor Tg4 is connected to a second terminal of the third transistor Tg3. A control terminal of the fourth transistor Tg4 is connected to a control terminal and the first terminal of the second transistor Tg2.

A first terminal of the fifth transistor Tg5 is connected to the first terminal of the reference capacitor CF. A second terminal of the fifth transistor Tg5 is connected to the second terminal of the third transistor Tg3 and a second terminal of the fourth transistor Tg4. A control terminal of the fifth transistor Tg5 is connected to the first terminal of the fourth transistor Tg4.

A first terminal of the input resistor Rg is connected to the control terminal of the fifth transistor Tg5. A first terminal of the input capacitor Cg is connected to a second terminal of the input resistor Rg. A second terminal of the input capacitor Cg is connected to the second terminal of the fifth transistor Tg5.

Another difference between the fifth and fourth embodiments is that, as shown in FIG. 5, in the fifth embodiment, the low-dropout regulator 2000 of the present disclosure further includes an output resistor Rout. In practice, the low-dropout regulator 2000 of the present disclosure as shown in FIGS. 1 to 4 may also include the output resistor Rout shown in FIG. 5. As shown in FIG. 5, a first terminal of the output resistor Rout is connected to the output node NOUT, and a second terminal of the output resistor Rout is grounded.

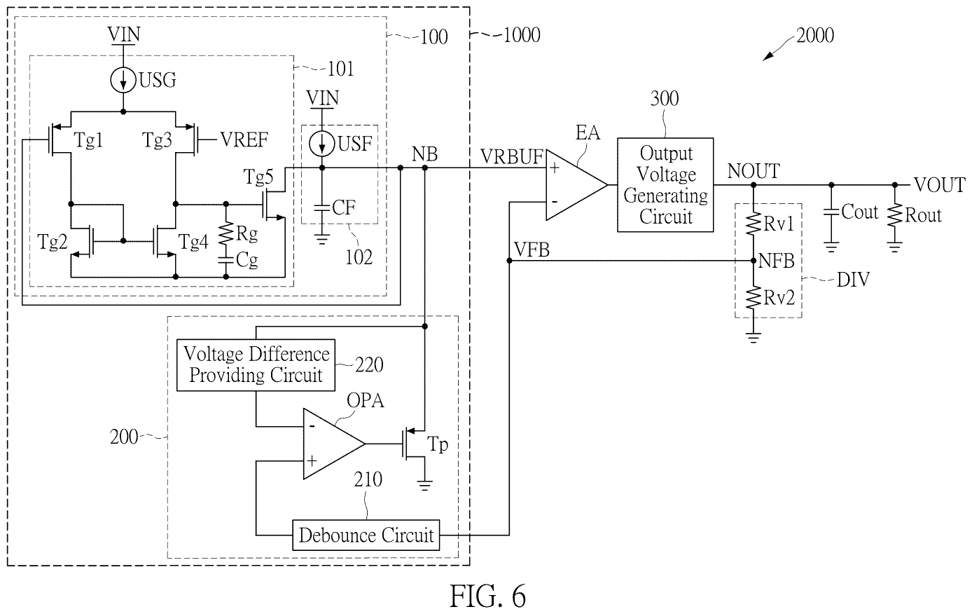

Reference is made to FIG. 6, which is a low-dropout regulator and a short-circuit recovery soft-start protection circuit according to a sixth embodiment of the present disclosure.

The descriptions of the sixth embodiment of the present disclosure that are the same as the descriptions of the first to fifth embodiments of the present disclosure are not repeated herein. A difference between the sixth and fifth embodiments of the present disclosure is that, as shown in FIG. 6, in the sixth embodiment, the low-dropout regulator 2000 of the present disclosure further includes an output voltage generating circuit 300. An input terminal of the output voltage generating circuit 300 is connected to the output terminal of the error amplifier EA. An output terminal of the output voltage generating circuit 300 is connected to the output node NOUT.

The output voltage generating circuit 300 is configured to output the output voltage signal VOUT to the output node NOUT, according to a voltage of an error amplified signal from the output terminal of the error amplifier EA.

For example, the output voltage generating circuit 300 may include a signal generator circuit, a voltage convertor circuit, or any combination thereto.

In conclusion, the present disclosure provides the low-dropout regulator and the short-circuit recovery soft-start protection circuit applied thereto. When the short-circuit event occurs in the output terminal of the low-dropout regulator, the short-circuit recovery soft-start protection circuit of the present disclosure is able to pull down the soft startup reference voltage of the input terminal of the low-dropout regulator for pulling down the output voltage signal of the output terminal of the low-dropout regulator. Therefore, the low-dropout regulator is prevented from being damaged by the overshoot of the output voltage thereof.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A low-dropout regulator, comprising:
an error amplifier, wherein a first input terminal of the error amplifier is connected to a buffer reference node, and an output terminal of the error amplifier is connected to a feedback node and a second input terminal of the error amplifier; and
a short-circuit recovery soft-start protection circuit including:
a clamp circuit, including:
an operational amplifier having a first input terminal and a second input terminal, wherein the second input terminal is connected to the feedback node;
a voltage difference providing circuit connected between the buffer reference node and the first input terminal of the operational amplifier, and configured to provide a voltage difference between the buffer reference node and the first input terminal of the operational amplifier; and
a switch component, wherein a first terminal of the switch component is connected to the buffer reference node, a second terminal of the switch component is grounded, and a control terminal of the switch component is connected to an output terminal of the operational amplifier; and
a soft-switching reference circuit connected to the buffer reference node and configured to charge a voltage of the buffer reference node to a reference voltage.

2. The low-dropout regulator according to claim 1, further comprising:
a voltage dividing circuit, wherein the output terminal of the error amplifier is connected to an output node, the voltage dividing circuit is connected between the output node and the feedback node, and the voltage dividing circuit is configured to divide an output voltage of the output node to output a feedback voltage to the feedback node.

3. The low-dropout regulator according to claim 1, wherein the clamp circuit further includes:
a debounce circuit connected between the feedback node and the second input terminal of the operational amplifier, wherein the debounce circuit is configured to receive a feedback signal from the feedback node, and only transmit a waveform having a frequency being larger than a frequency threshold in the feedback signal to the second input terminal of the operational amplifier.

4. The low-dropout regulator according to claim 1, wherein the soft-switching reference circuit includes:
a buffer reference voltage generating circuit connected to the buffer reference node; and
a charging circuit connected to the buffer reference node and the buffer reference voltage generating circuit, and configured to charge the buffer reference voltage generating circuit such that the buffer reference voltage generating circuit outputs a charging voltage to the buffer reference node.

5. The low-dropout regulator according to claim 4, wherein the buffer reference voltage generating circuit includes:
a reference capacitor, wherein a first terminal of the reference capacitor is connected to the charging circuit and the first input terminal of the error amplifier, and a second terminal of the reference capacitor is grounded.

6. The low-dropout regulator according to claim 5, wherein the buffer reference voltage generating circuit further includes:
a reference current source connected to the first terminal of the reference capacitor and configured to supply a reference input current to the reference capacitor.

7. The low-dropout regulator according to claim 5, wherein the charging circuit includes:
a first transistor, wherein a first terminal of the first transistor is coupled to an input voltage, and a control terminal of the first transistor is connected to the buffer reference node;
a second transistor, wherein a first terminal of the second transistor is connected to a second terminal of the first transistor;
a third transistor, wherein a first terminal of the third transistor is coupled to the input voltage, and a control terminal of the third transistor is coupled to the reference voltage;
a fourth transistor, wherein a first terminal of the fourth transistor is connected to a second terminal of the third transistor, and a control terminal of the fourth transistor is connected to a control terminal and the first terminal of the second transistor; and
a fifth transistor, wherein a first terminal of the fifth transistor is connected to the first terminal of the reference capacitor, a second terminal of the fifth transistor is connected to the second terminal of the third transistor and a second terminal of the fourth transistor, and a control terminal of the fifth transistor is connected to the first terminal of the fourth transistor.

8. The low-dropout regulator according to claim 7, wherein the charging circuit further includes:
an input current source, wherein an input terminal of the input current source is coupled to the input voltage, and an output terminal of the input current source is connected to the first terminal of the first transistor and the first terminal of the third transistor.

9. The low-dropout regulator according to claim 7, wherein the charging circuit further includes:
an input resistor, wherein a first terminal of the input resistor is connected to the control terminal of the fifth transistor; and
an input capacitor, wherein a first terminal of the input capacitor is connected to a second terminal of the input resistor, and a second terminal of the input capacitor is connected to the second terminal of the fifth transistor.

10. A short-circuit recovery soft-start protection circuit, which is applicable to a low-dropout regulator, wherein a first input terminal of the low-dropout regulator is connected to a buffer reference node, an output terminal of the low-dropout regulator is connected to a feedback node and a second input terminal of the low-dropout regulator, and the short-circuit recovery soft-start protection circuit comprising:
a clamp circuit including:
an operational amplifier having a first input terminal and a second input terminal, wherein the second input terminal of the operational amplifier is connected to the feedback node;
a voltage difference providing circuit connected between the buffer reference node and the first input terminal of the operational amplifier, and configured to provide a voltage difference between the buffer reference node and the first input terminal of the operational amplifier; and
a switch component, wherein a first terminal of the switch component is connected to the buffer reference node, a second terminal of the switch component is grounded, and a control terminal of the switch component is connected to an output terminal of the operational amplifier; and
a soft-switching reference circuit connected to the buffer reference node and configured to charge a voltage of the buffer reference node to a reference voltage.

11. The short-circuit recovery soft-start protection circuit according to claim 10, wherein the low-dropout regulator includes an error amplifier, a first input terminal of the error amplifier is connected to the buffer reference node, and an output terminal of the error amplifier is connected to the feedback node and a second input terminal of the error amplifier.

12. The short-circuit recovery soft-start protection circuit according to claim 10, wherein the low-dropout regulator further includes:
a voltage dividing circuit connected between an output node and the feedback node and configured to divide an output voltage of the output node to output a feedback voltage to the feedback node, wherein the output node is connected to the output terminal of the error amplifier.

13. The short-circuit recovery soft-start protection circuit according to claim 10, wherein the charging circuit further includes:
a debounce circuit connected between the feedback node and the second input terminal of the operational amplifier, wherein the debounce circuit is configured to receive a feedback signal from the feedback node, and only transmit a waveform having a frequency being larger than a frequency threshold in the feedback signal to the second input terminal of the operational amplifier.

14. The short-circuit recovery soft-start protection circuit according to claim 10, wherein the charging circuit further includes:
a buffer reference voltage generating circuit connected to the buffer reference node; and
a charging circuit connected to the buffer reference node and the buffer reference voltage generating circuit, and configured to charge the buffer reference voltage generating circuit such that the buffer reference voltage generating circuit outputs a charging voltage to the buffer reference node.

15. The short-circuit recovery soft-start protection circuit according to claim 14, wherein the buffer reference voltage generating circuit includes:
a reference capacitor, wherein a first terminal of the reference capacitor is connected to the charging circuit and the first input terminal of the error amplifier, and a second terminal of the reference capacitor is grounded.

16. The short-circuit recovery soft-start protection circuit according to claim 15, wherein the buffer reference voltage generating circuit includes:
a reference current source connected to the first terminal of the reference capacitor and configured to supply a reference input current to the reference capacitor.

17. The short-circuit recovery soft-start protection circuit according to claim 16, wherein the charging circuit includes:
a first transistor, wherein a first terminal of the first transistor is coupled to an input voltage, and a control terminal of the first transistor is connected to the buffer reference node;
a second transistor, wherein a first terminal of the second transistor is connected to a second terminal of the first transistor;
a third transistor, wherein a first terminal of the third transistor is coupled to the input voltage, and a control terminal of the third transistor is coupled to the reference voltage;
a fourth transistor, wherein a first terminal of the fourth transistor is connected to a second terminal of the third transistor, and a control terminal of the fourth transistor is connected to a control terminal and the first terminal of the second transistor; and
a fifth transistor, wherein a first terminal of the fifth transistor is connected to the first terminal of the reference capacitor, a second terminal of the fifth transistor is connected to the second terminal of the third transistor and a second terminal of the fourth transistor, and a control terminal of the fifth transistor is connected to the first terminal of the fourth transistor.

18. The short-circuit recovery soft-start protection circuit according to claim 17, wherein the charging circuit further includes:
an input current source, wherein an input terminal of the input current source is coupled to the input voltage, and an output terminal of the input current source is connected to the first terminal of the first transistor and the first terminal of the third transistor.

19. The short-circuit recovery soft-start protection circuit according to claim 17, wherein the charging circuit further includes:
an input resistor, wherein a first terminal of the input resistor is connected to the control terminal of the fifth transistor; and
an input capacitor, wherein a first terminal of the input capacitor is connected to a second terminal of the input resistor, and a second terminal of the input capacitor is connected to the second terminal of fifth transistor.
